(19) United States
(12) Patent Application Publication
(10) Pub. No.: US 2004/0074934 A1
(43) Pub. Date: Apr. 22, 2004

(54) Can equipped with a pouring spout

(76) Inventor: Emmanuel Velut, Lons Le Saunier (FR)

Correspondence Address: Ralph A. Dowell, Dowell & Dowell, P.C., Suite 309, 1215 Jefferson Davis Hwy., Arlington, VA, 22202, US

(21) Appl. No.: 10/347,261

(22) Filed: Jan. 21, 2003

(30) Foreign Application Priority Data
Oct. 16, 2002 (EP) 02356203.6

(51) Int. Cl. B67D 3/00

(52) U.S. Cl. 222/539

(57) ABSTRACT

This invention relates to a can which comprises enclosure walls, a neck allowing access to the interior volume of the can, a stopper adapted to be removably fixed on this neck, as well as a pouring spout provided with a pouring end.

This pouring spout is mobile between a position of storage, in which its pouring end is received in the interior volume of the can, and in which this spout is maintained by wedging between opposite walls of the neck and of the stopper, and a position of use in which this spout is fixed directly on the neck.

### FIELD OF THE INVENTION

The present invention relates to a can equipped with a pouring spout.

### BACKGROUND OF THE INVENTION

Such a can is made of a plastics material, such as polyethylene, particularly high-density polyethylene, or polypropylene.

It comprises a bottom, from which extend side walls terminating in an upper wall. The latter is provided with a neck allowing access to the interior volume of the can.

Furthermore, a pouring spout is provided, which may be removably fixed on the neck. This spout, which is provided with a narrowed end, guarantees an easy pouring of the substance initially present in the interior volume of the can.

It is an object of the invention to propose a can equipped with a pouring spout, of the type described hereinbefore, which is economical to manufacture and particularly simple and convenient to use.

### SUMMARY OF THE INVENTION

To that end, the present invention relates to a can made of plastics material, comprising enclosure walls, a neck allowing access to the interior volume of the can, a stopper adapted to be removably fixed on this neck, as well as a pouring spout provided with a pouring end, characterized in that this pouring spout is mobile between a position of storage, in which its pouring end is received in the interior volume of the can, and in which this spout is maintained by wedging between opposite walls of the neck and of the stopper, and a position of use in which this spout is fixed directly on the neck.

According to advantageous but non-obligatory aspects of the invention, the can incorporates one or more of the following characteristics:

in the position of storage, the pouring spout is maintained by wedging between the end of a threaded cylinder of the neck and a bottom of the stopper.

a terminal flange of the pouring spout is maintained by wedging, in the position of storage, between the end of this cylinder and this bottom.

in the position of storage, the pouring spout is connected to the stopper.

in the position of storage, the pouring spout is connected to the stopper, by wedging of its flange against inner side walls of the stopper.

in the position of use, the pouring spout is fixed on the neck by elastic clipping.

the pouring spout is fixed on the end of the threaded cylinder.

the pouring spout is fixed, by its flange, on the end of the cylinder.

the pouring spout presents a truncated principal part from which extend the pouring end and the flange which is opposite said end.

### BRIEF DESCRIPTION OF THE DRAWINGS

The invention will be more readily understood on reading the following description given by way of non-limiting example and made with reference to the accompanying drawings, in which:

FIG. 1 is a side view, with parts torn away, illustrating a can according to the invention, in its position of storage, and

FIGS. 2 and 3 are side views similar to FIG. 1, illustrating the can in two other positions, namely an intermediate position and a position of use, respectively.

### DESCRIPTION OF PREFERRED EMBODIMENT

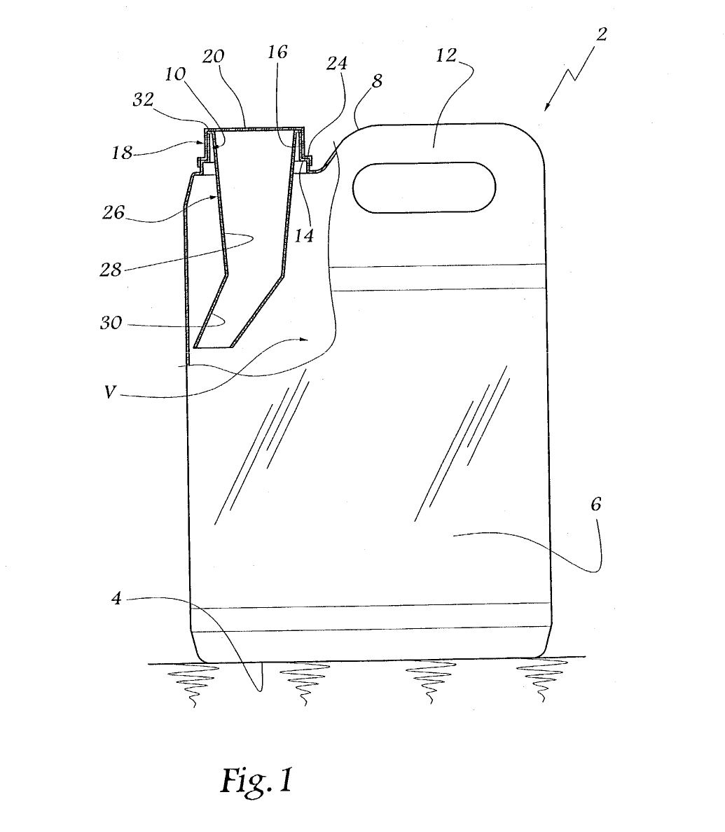

Referring now to the drawings, the can shown in FIGS. 1 to 3, which is generally designated by reference 2, comprises a bottom 4, side walls 6, and an upper wall 8. The latter is provided with a neck 10 allowing access to the interior volume V of the can, and with a handle 12.

This can is made of a plastics material, such as high-density polyethylene or propylene. It is particularly intended to receive a liquid substance.

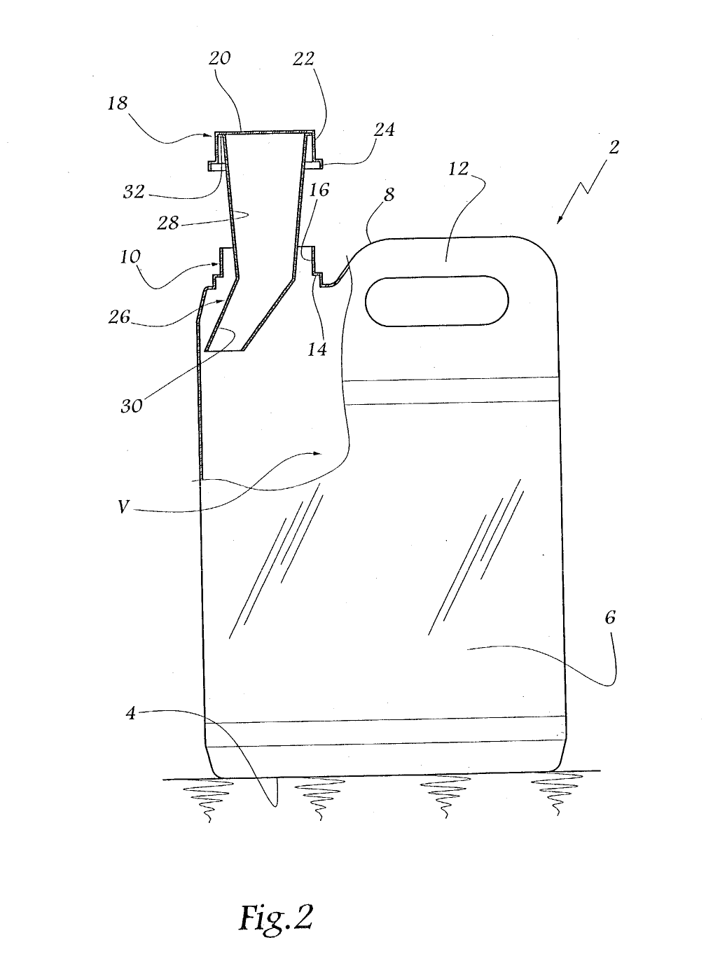

The neck 10, more readily visible in FIG. 2, comprises a re-entrant shoulder 14 terminating in a threaded cylinder 16. This neck is capable of removably receiving a stopper generally designated by reference 18.

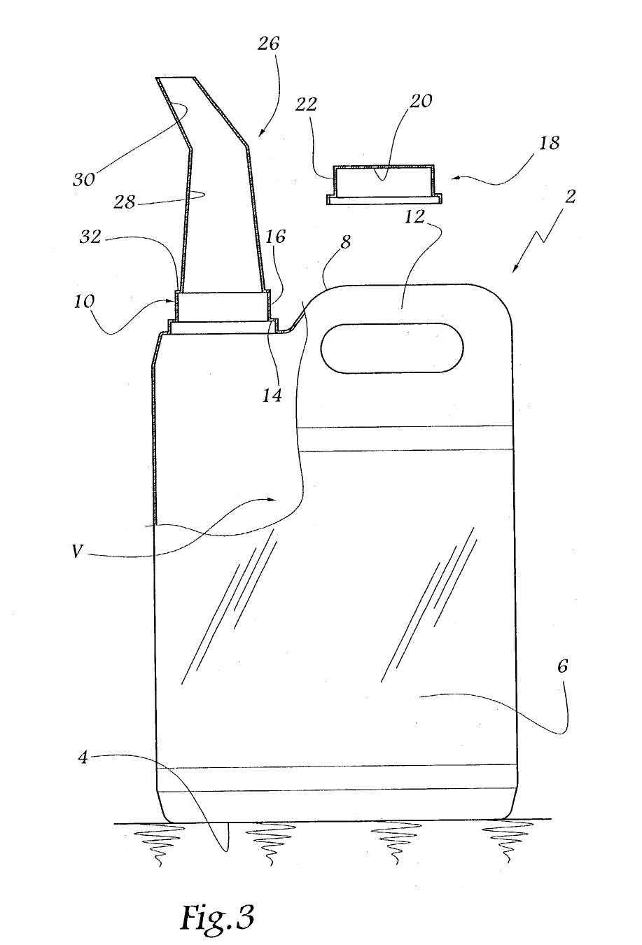

As is shown more precisely in FIG. 3, this stopper 18 comprises a bottom 20 from which extend tapped side walls 22 intended to cooperate with the threaded cylinder 16 of the neck. These walls 22 extend, opposite the bottom 20, in a shoulder 24 intended to cooperate with that, 14, made on the neck.

In addition, the can 2 is equipped with a pouring spout generally designated by reference 26, which comprises a truncated principal part 28 extended by a narrowed pouring end 30. Furthermore, a flange 32 extends from this principal part 28, opposite the afore-mentioned end 30.

FIG. 1 illustrates the can 2 described hereinabove in its position of storage.

In this configuration, the flange 32 of the pouring spout 26 abuts against the free end of the cylinder 16 of the neck 10. This flange is maintained by wedging between this cylinder and the bottom 20 of the stopper.

Furthermore, the principal part 28 of the spout extends through the neck 10, while the pouring end 30 is received in the interior volume V of the can.

It should be noted that, in this position of storage, the arrangement of FIG. 1 provides the can with two levels of seal.

Being given that the principal part 28 is truncated, this guarantees a first degree of seal with respect to the opposite walls of the neck. In addition, the stopper 18 is provided with a lip (not shown), which cooperates with the flange 32 so as to ensure a second degree of seal.

If it is desired to pour out the substance present in the can 1 via the spout 26, the stopper 18 must firstly be removed by unscrewing it. This phase is illustrated in FIG. 2.

This then makes it possible to withdraw the pouring spout 26 out of the interior volume V of the can 2.

To that end, as illustrated in FIG. 2, it is possible to give this spout 26 such radial dimensions that, in the position of storage, the flange 32 is immobilized, by wedging, against the side walls 22 of the stopper 18. In that case, when this stopper 18 is withdrawn from the neck 10, this operation makes it possible also to disengage the pouring spout 26, which is connected to this stopper.

By way of variant (not shown), it is possible for the pouring spout not to be immobilized with respect to the stopper 18. In that case, when the latter is removed from the neck 10, the user is able to manually grip the flange 32 which abuts against the end of the cylinder 16, so as to extract the pouring spout 26.

Finally, as shown in FIG. 3, the user upturns the pouring spout 26, then fixes it directly on the neck 10 without employing the stopper 18. More precisely, this fixation is ensured by elastic clipping of the flange 32 on the end of the threaded cylinder 16. To that end, this flange is for example provided with known means (not shown) allowing such clipping.

Once the can 2 is in its position of use, it is then possible easily to pour out the substance initially present in the interior volume V of the can. It should be noted that, in this configuration of FIG. 3, the stopper 18 is not connected to the can 2.

Thanks to the invention, the objectives mentioned hereinabove are attained.

In effect, the can according to the invention is economical to manufacture, since it employs a restricted number of constituent elements. Furthermore, the different types of fixation between these elements may be ensured conventionally without incurring substantial costs.

In addition, the can of the invention is simple to use, since it employs a small number of operational steps which are particularly easy to carry out.

Finally, the presence of the pouring spout provides the can of the invention with a very satisfactory seal, being given that it guarantees the existence of two different degrees of seal.

In this respect, it should be noted that, if this pouring spout did not exist, such a seal would not be suitably obtained.

1. Can made of plastics material, comprising enclosure walls, a neck allowing access to the interior volume of the can, a stopper adapted to be removably fixed on this neck, as well as a pouring spout provided with a pouring end, wherein this pouring spout is mobile between a position of storage, in which its pouring end is received in the interior volume of the can, and in which this spout is maintained by wedging between opposite walls of the neck and of the stopper, and a position of use in which this spout is fixed directly on the neck.

2. Can according to claim 1, wherein, in the position of storage, the pouring spout is maintained by wedging between the end of a threaded cylinder of the neck and a bottom of the stopper.

3. Can according to claim 2, wherein a terminal flange of the pouring spout is maintained by wedging, in the position of storage, between the end of this cylinder and this bottom.

4. Can according to claim 1, wherein, in the position of storage, the pouring spout is connected to the stopper.

5. Can according to claim 3, wherein, in the position of storage, the pouring spout is connected to the stopper, by wedging of its flange against inner side walls of the stopper.

6. Can according to claim 1, wherein, in the position of use, the pouring spout is fixed on the neck by elastic clipping.

7. Can according to claim 6, wherein the pouring spout is fixed on the end of the threaded cylinder.

8. Can according to claim 7, wherein the pouring spout is fixed, by its flange, on the end of the cylinder.

9. Can according to claim 3, wherein the pouring spout presents a truncated principal part from which extend the pouring end and the flange which is opposite said end.
